(19) United States
(12) Patent Application Publication
(10) Pub. No.: US 2026/0299300 A1
(43) Pub. Date: Oct. 1, 2026

(54) METHODS FOR AG MIRROR ENCAPSULATION

(71) Applicant: Applied Materials, Inc., Santa Clara, CA (US)

(72) Inventors: Ludovic GODET, Sunnyvale, CA (US); Rami HOURANI, Santa Clara, CA (US); Yue CHEN, Sunnyvale, CA (US); Erica CHEN, Cupertino, CA (US); Rutger MEYER TIMMERMAN THIJSSEN, Sunnyvale, CA (US)

(21) Appl. No.: 19/479,096

(22) PCT Filed: Apr. 26, 2024
(86) PCT No.: PCT/US2024/026666

§ 371 Date: Oct. 27, 2025

Related U.S. Application Data
(60) Provisional application No. 63/462,747, filed on Apr. 28, 2023.

(51) Int. Cl. G02B 27/01

(52) U.S. Cl. CPC G02B 27/0172

(57) ABSTRACT

The present disclosure provides a method including depositing a mirror over a waveguide, the waveguide having an input coupler and an output coupler. An encapsulation layer is deposited over the mirror. A resist is formed over the input coupler, exposing a residual encapsulation portion of the encapsulation layer over the non-input coupler area. The residual encapsulation portion of the encapsulation layer is removed, exposing a residual mirror portion of the mirror over the non-input coupler area. The residual mirror portion of the mirror of the input coupler is removed, exposing the non-input area of the waveguide. The resist over the input coupler is removed, in which the waveguide has the mirror only over the input coupler and the encapsulation layer is only over the mirror.

### BACKGROUND

### Field

Embodiments of the present disclosure generally relate to waveguides for augmented, virtual, and mixed reality.

### Description of the Related Art

A waveguide may be used to manipulate the propagation of light using structures of the waveguide formed on a substrate. The waveguide includes an arrangement of structures with in-plane dimensions smaller than half a design wavelength of light. The structures have sub-micron critical dimensions, e.g., nanosized dimensions, to alter light propagation by manipulating photons in order to induce localized phase discontinuities (i.e., abrupt changes of phase over a distance smaller than the wavelength of light). A metal coating may be placed over the structures, in which the metal coating acts as a mirror to direct light and enhance device efficiency. However, the metal coatings often corrode in ambient atmospheres by reacting with oxygen and/or sulfur-containing gases.

Accordingly, what is needed is an improved method of forming a waveguide.

### SUMMARY

The present disclosure provides methods. The methods include depositing a mirror over a waveguide, the waveguide having an input coupler and an output coupler. An encapsulation layer is deposited over the mirror. A resist is formed over the input coupler, exposing a residual encapsulation portion of the encapsulation layer over the non-input coupler area. The residual encapsulation portion of the encapsulation layer is removed, exposing a residual mirror portion of the mirror over the non-input coupler area. The residual mirror portion of the mirror of the input coupler is removed, exposing the non-input area of the waveguide. The resist over the input coupler is removed, in which the waveguide has the mirror only over the input coupler and the encapsulation layer is only over the mirror.

The present disclosure also provides methods. The methods include depositing a mirror over a waveguide, in which the waveguide has an input coupler and an output coupler. A first resist is formed over the input coupler, exposing a residual mirror portion of the mirror over the non-input coupler area. The residual mirror portion of the mirror over the non-input coupler area is exposed. The first resist is removed. An encapsulation layer is deposited over the mirror and the non-input coupler area. A second resist is formed over the mirror, in which a residual encapsulation portion of the encapsulation layer over the non-input coupler area is exposed. The residual encapsulation portion is removed, in which the non-input coupler area of the waveguide is exposed. The second resist is removed, in which the waveguide has the mirror only over the input coupler and the encapsulation layer is only over the mirror, or over the mirror and exterior portions of the input coupler surrounding a grating of the input coupler.

The present disclosure also provides methods. The methods include depositing a mirror comprising silver or aluminum over a waveguide. The waveguide has an input coupler and an output coupler. An encapsulation layer comprising chromium or silicon nitride is deposited over the mirror. A resist is formed over the input coupler. A residual encapsulation portion of the encapsulation layer over the non-input coupler area is exposed. The residual encapsulation portion of the encapsulation layer and a residual mirror portion of the mirror over the non-input coupler area is removed. The resist over the input coupler is removed.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the present disclosure and are therefore not to be considered limiting of its scope, may admit to other equally effective embodiments.

FIG. 1 is schematic view of a waveguide according to aspects of the disclosure.

FIG. 2 is a flow diagram of a method of forming a waveguide according to aspects of the disclosure.

FIGS. 3A-3D are schematic, cross-sectional views of a substrate during the method according to aspects of the disclosure.

FIG. 4 is a flow diagram of a method of forming a waveguide according to aspects of the disclosure.

FIGS. 5A-5G are schematic, cross-sectional views of a substrate during the method according to aspects of the disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

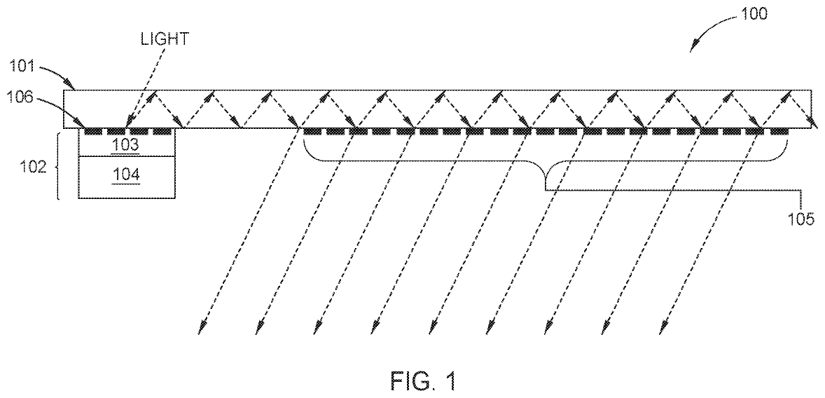

Embodiments of the present disclosure generally relate to methods of fabricating input couplers of waveguides for augmented reality and virtual reality devices. The methods described herein provide for a waveguide having mirror only over the input coupler with an encapsulation layer only over the mirror or over the mirror and exterior portions of the input coupler surrounding a grating of the input coupler, as shown in FIG. 1. The mirror layer only over the input coupler with the encapsulation layer provides a barrier to oxygen, sulfur, and moisture ingress. The encapsulation layer protects the mirror from corroding in ambient atmospheres.

The encapsulation layer of the present disclosure does not require e-beam PVD deposition processes. Instead, other deposition processes e.g., PVD or printing methods, such as screen-printing or inkjet printing, may be utilized, in which these PVD or printing methods reduce cost and improve process flow. The deposition processes described herein allow for an encapsulation layer to be deposited without comprising optical performance of the AR/VR device. Overall, the present disclosure provides a method of forming an input coupler having reflectivity and protection from oxidation or other chemical reaction.

A waveguide 100 includes a substrate 101. The substrate 101 may be selected to transmit light at the wavelength of operation. Without limitation, in some embodiments, the substrate 101 is configured such that the substrate 101 transmits greater than or equal to about 50%, 60%, 70%, 80%, 90%, 95%, 99% of the UV region of the light spectrum. The substrate 101 may be formed from any suitable material, provided that the substrate 101 can adequately transmit light of the wavelength of operation and can serve as an adequate support for at least the arrangement of the waveguide structures 106 and the encapsulation layer 104. In some embodiments, which can be combined with other embodiments described herein, the material of substrate 101 has a refractive index that is relatively low, as compared to the refractive index of materials used in each of the waveguide structures 106. Substrate selection may include substrates of any suitable material, including, but not limited to, semiconductor, doped semiconductor, amorphous dielectrics, non-amorphous dielectrics, crystalline dielectrics, silicon oxide, polymers, and combinations thereof. In some embodiments, which can be combined with other embodiments described herein, the substrate 101 includes a transparent material. The substrate 101 is transparent with an absorption coefficient less than 0.001. Examples may include, but are not limited to, an oxide, sulfide, phosphide, telluride, and combinations thereof. For example, the substrate 101 includes, but is not limited to, silicon (Si), silicon dioxide (SiO₂), germanium (Ge), silicon germanium (SiGe), silicon carbide (SiC), sapphire, glass, or combinations thereof.

The waveguide 100 includes an input coupler 102. The input coupler 102 includes a first arrangement of waveguide structures 106. The waveguide structures 106 may be any suitable shape to transmit and/or direct incoming light to the substrate 101. For example, and without limitation, the waveguide structures 106 may have square or rectangular cross-sections. As a further non-limiting example, the waveguide structures 106 have may cross-sections having circular, triangular, elliptical, regular polygonal, irregular polygonal, and/or irregular shaped cross-sections. The cross-sections of the waveguide structures 106 on the substrate 101 may be different.

The waveguide structures 106 can include materials, not limited to, titanium dioxide (TiO₂), zinc oxide (ZnO), tin dioxide (SnO₂), aluminum-doped zinc oxide (AZO), fluorine-doped tin oxide (FTO), cadmium stannate (tin oxide) (CTO), zinc stannate (tin oxide) (SnZnO₃), and silicon containing materials. The silicon containing materials may include at least one of silicon nitride (Si₃N₄) or amorphous silicon (a-Si) containing materials. The waveguide structures 106 may have a refractive of about 1.8 or greater, and absorption coefficient less than 0.001.

A mirror 103 is disposed on the input coupler 102 of the waveguide structures 106, in which the mirror 103 is not disposed over the output coupler 105. The mirror 103 is a coating capable of reflecting one or more wavelengths of light that enter the substrate 101 and proceed towards input coupler 102. The mirror 103 is not disposed over the output coupler 105. The mirror 103 may be any suitable material capable of reflecting more than 90% of light, e.g., about 90%, about 91 %, about 92%, about 93%, about 94%, about 95%, about 96%, about 97%, about 98%, about 99%, or about 100%. For example, and without limitation, the mirror 103 may be silver, aluminum, gold, nanocrystalline oxides, e.g., titanium dioxide, zinc oxide, magnesium oxide, aluminum oxide, or the like. For example, the mirror 103 can be silver. For example, the mirror 103 can be aluminum.

The input coupler 102 includes an encapsulation layer 104 disposed over the mirror 103, in which the encapsulation layer 104 is disposed over the mirror 103, which is only disposed over the input coupler 102. In some embodiments, which may be combined with other embodiments, the encapsulation layer 104 is disposed only on a top side of the mirror 103. In other embodiments, which may be combined with other embodiments, the encapsulation layer 104 is disposed over a top side and one or more side walls of the mirror 103.

The encapsulation layer 104 contains one or more materials for encapsulating or protecting the underlying layers, namely the mirror 103 and the substrate 101 of the waveguide 100. For example, the encapsulation layer 104 may include chromium, silicon nitride, silicon oxide, e.g., silicon dioxide, aluminum oxide, magnesium oxide, dopants thereof, or any combination thereof. The encapsulation layer 104 may be formed using one or more vapor deposition processes that do not utilize a plasma such as polymer printing, e.g., inkjet printing or screen printing. The encapsulation layer 104 may be formed using one or more vapor deposition processes which utilize plasma such as PVD or sputtering processes, a furnace CVD (FCVD) process, a PE-CVD process, a PE-ALD process, or other plasma processes.

In one or more examples, the encapsulation layer 104 may be deposited by a PVD process which includes generating ozone or an oxygen plasma while depositing the encapsulation layer 104. For example, silicon oxide may be deposited in a magnetron sputtering PVD chamber using a silicon target and depositing reactively with a plasma containing argon and oxygen (Ar/O₂). In other examples, the encapsulation layer 104 is deposited by inkjet printing with one or more polymers or metals over the mirror 103.

The encapsulation layer 104 has a thickness of about 10 nm, about 15 nm, about 20 nm, about 25 nm, about 30 nm, about 35 nm, about 40 nm, about 45 nm, or about 50 nm to about 55 nm, about 60 nm, about 70 nm, about 80 nm, about 90 nm, about 100 nm, about 120 nm, about 135 nm, about 150 nm, about 180 nm, about 200 nm, or thicker. For example, the encapsulation layer 104 has a thickness of about 10 nm to about 200 nm, about 10 nm to about 180 nm, about 10 nm to about 150 nm, about 10 nm to about 120 nm, about 10 nm to about 100 nm, about 10 nm to about 80 nm, about 10 nm to about 60 nm, about 10 nm to about 50 nm, about 10 nm to about 40 nm, about 10 nm to about 20 nm, about 15 nm to about 50 nm, about 20 nm to about 200 nm, about 20 nm to about 180 nm, about 20 nm to about 150 nm, about 20 nm to about 120 nm, about 20 nm to about 100 nm, about 20 nm to about 80 nm, about 20 nm to about 60 nm, about 20 nm to about 50 nm, about 20 nm to about 40 nm, about 20 nm to about 30 nm, about 40 nm to about 200 nm, about 40 nm to about 180 nm, about 40 nm to about 150 nm, about 40 nm to about 120 nm, about 40 nm to about 100 nm, about 40 nm to about 80 nm, about 40 nm to about 60 nm, about 40 nm to about 50 nm, about 50 nm to about 60 nm, about 50 nm to about 150 nm, about 80 nm to about 120 nm, or about 90 nm to about 110 nm. In some embodiments, the encapsulation layer 104 has a refractive index of about 1.0 to about 1.5, e.g., about 1.0 to about 1.4, about 1.1 to about 1.4, about 1.2 to about 1.4, or about 1.2 to about 1.3.

The waveguide 100 includes an output coupler 105. The output coupler 105 includes a second arrangement of waveguide structures 106 described herein. The second arrangement of waveguide structures 106 direct refracted or reflected light within the substrate 101 when exiting the substrate 101 and/or the waveguide 100. The waveguide structures 106 may have square, rectangular, circular, triangular, elliptical, regular polygonal, irregular polygonal, and/or irregular shaped cross-sections. The second arrangement of waveguide structures 106 have a depth and a critical dimension, as described herein. In some embodiments, a medium fills one or more gaps between the second arrangement of waveguide structures 106 of the output coupler 105. In some embodiments, the medium includes a refractive index of about 1. For example, medium filling one or more gaps between the second arrangement of waveguide structures 106 of the output coupler can be air. The second arrangement of waveguide structures 106 have a structure refractive index as described herein.

The plurality of waveguide structures 106 include, but are not limited to, one or more of silicon (e.g. amorphous silicon), silicon carbide (SIC), silicon oxycarbide (SiOC), titanium dioxide (TiO₂), silicon dioxide (SiO₂), vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (Si₃N₄), zirconium dioxide (ZrO₂), niobium oxide (Nb₂O₅), cadmium stannate (Cd₂SnO₄), or silicon carbon-nitride (SiCN) containing materials.

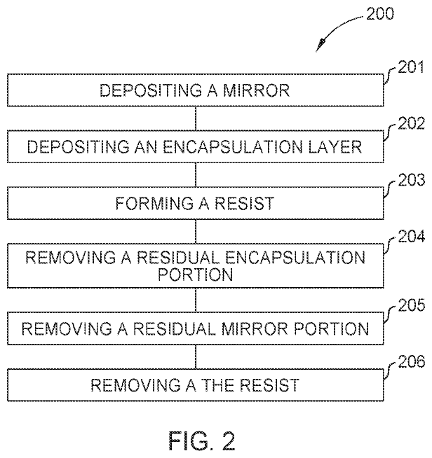

Now referring to FIG. 2, a method 200 includes depositing a mirror 103 over a waveguide 100. The waveguide 100 includes an input coupler 102 and an output coupler 105. The mirror 103 is deposited over a plurality of waveguide structures 106 of the waveguide 100. The mirror 103 can be deposited by PVD or another vapor deposition process (e.g., CVD or ALD). The mirror 103 can be deposited or otherwise formed by one or more processes or techniques, such as CVD, plasma-enhanced CVD (PE-CVD), sub-atmospheric CVD (SA-CVD), high density plasma CVD (HDP-CVD), flowable CVD, ALD, furnace or thermal ALD, thermal ALD, plasma-enhanced ALD (PE-ALD), PVD, sputtering, evaporation deposition, ion beam deposition, inkjet printing, screen printing, or any combination thereof.

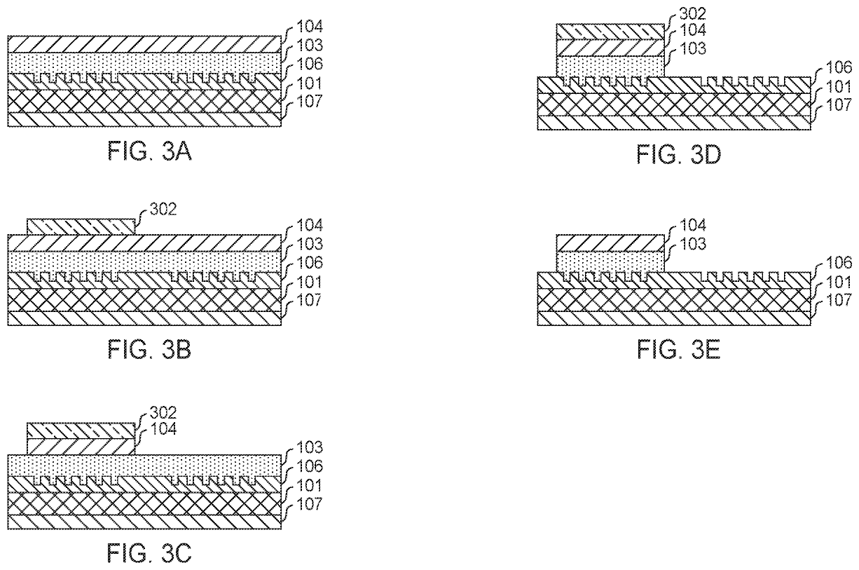

The method 200 includes, at operation 202, depositing an encapsulation layer 104 over the mirror 103, as shown in FIG. 3A. The encapsulation layer 104 is disposed above the mirror 103, as shown in FIG. 3A. An anti-reflective coating layer 107 is disposed beneath the substrate 101. The encapsulation layer 104 is chromium or silicon nitride.

At operation 203, a resist 302 is formed over the input coupler, as shown in FIG. 3B. A residual encapsulation portion of the encapsulation layer 104 over a non-input coupler area is exposed, as shown in FIG. 3B. The resist 302 protects the encapsulation layer 104 from being removed during subsequent processing steps.

The resist 302 can be deposited by a block photolithography procedure, e.g., spin-coating the resist, baking, exposing with patter, and developing the area to remove the resist at an area where the input coupler is not present on the waveguide.

At operation 204, the residual encapsulation portion of the encapsulation layer 104 is removed, exposing a residual mirror portion of the mirror 103 over a non-input coupler area that is exposed, as shown in FIG. 3C. The etching process at operation 204 may include a wet etching process using tetramethylammonium, potassium iodide, or iodine to etch the residual portion of the encapsulation layer 104. For example, the etching process may be a dry etch process, which provides good selectivity between the encapsulation layer 104 and the mirror 103. As a further non-limiting example, the etching process may be a wet etching process that avoids oxidation of the mirror 103 and potential contamination of the chamber. The etching process may etch all residual portions of the encapsulation layer 104, which are not covered by a resist 302, down to the mirror 103.

At operation 205, the residual mirror portion of the mirror 103 of the input coupler 102 is etched using an etching process, exposing the output coupler 105 of the waveguide 100, as shown in FIG. 3D. The etching process includes a wet etch process using tetramethylammonium, potassium iodide, or iodine. The wet etching process may etch all residual portions of the mirror 103, which are not covered by a resist 302 or the encapsulation layer 104, down to the plurality of optical structures 301.

At operation 206, the resist 302 is removed from the input coupler 102, as shown in FIG. 3E. The waveguide only has the mirror 103 over the input coupler 102 and the encapsulation layer 104 only over the mirror 103. The resist 302 is removed according to one or more etching processes. The etching process at operation 206 may include a dry etching process using O₂ plasma, an organic solvent such as propylene glycol methyl ether acetate (PGMEA,) or using a flood exposure procedure followed by tetramethylamoonium hydroxide (TMAH) solvent to etch the residual portion of the encapsulation layer 104. The etching process may remove the resist 302, such that the input coupler 102 includes an encapsulation layer 104 disposed on a mirror 103, which is disposed on a plurality of waveguide structures 106 on a substrate 101. This process allows for a single-block litho process of forming an encapsulated mirror on only an input coupler of a guide, not an output coupler, providing device efficiency and longevity of silver containing mirrors.

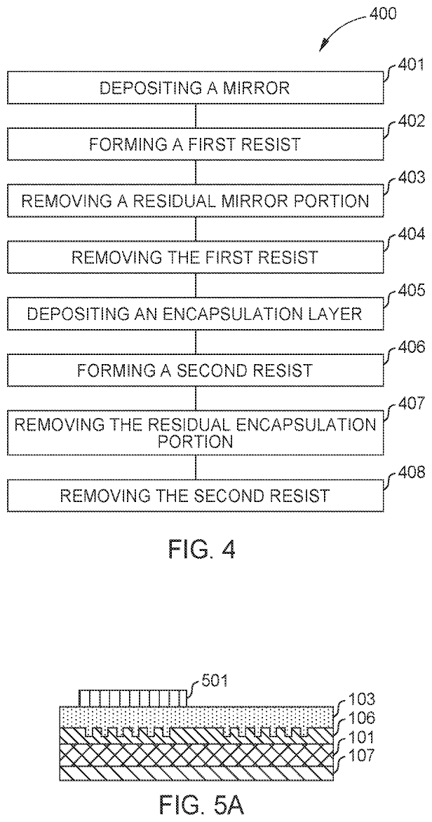

Now referring to FIG. 4, a method 400 includes, at operation 401, depositing a mirror 103 over a waveguide 100, in which the waveguide has an input coupler 102 and an output coupler 105. The mirror 103 is deposited over a plurality of waveguide structures 106 of the waveguide 100. The mirror 103 can be deposited by PVD or another vapor deposition process (e.g., CVD or ALD). The mirror 103 can be deposited or otherwise formed by one or more processes or techniques, such as CVD, plasma-enhanced CVD (PE-CVD), sub-atmospheric CVD (SA-CVD), high density plasma CVD (HDP-CVD), flowable CVD, ALD, furnace or thermal ALD, thermal ALD, plasma-enhanced ALD (PE-ALD), PVD, sputtering, evaporation deposition, ion beam deposition, inkjet printing, screen printing, or any combination thereof.

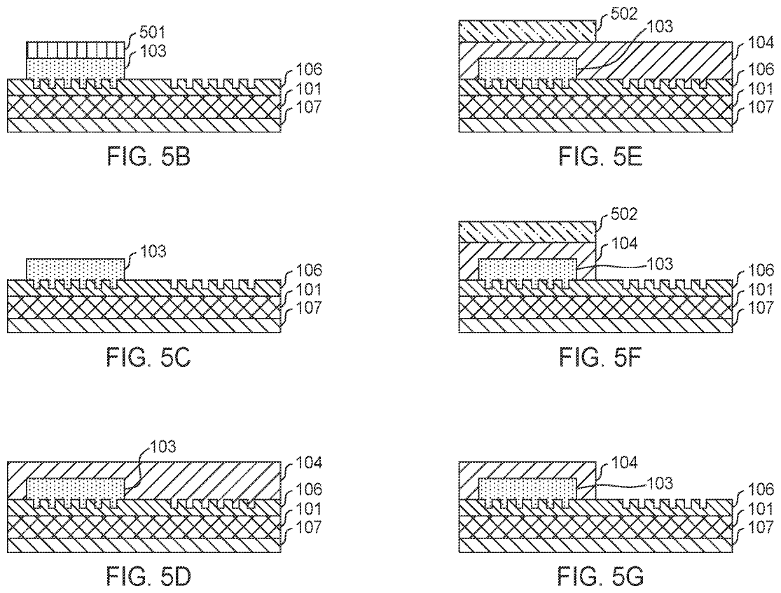

At operation 402, a first resist 501 is formed over the input coupler, in which the first resist is disposed above the mirror 103, as shown in FIG. 5A. A residual mirror portion of the mirror 103 is exposed over the output coupler 105. An anti-reflective coating layer 107 is disposed beneath the substrate 101. The first resist 501 includes any of the resist 302 as described above.

At operation 403, the residual mirror portion of the mirror 103 over the output coupler is removed, as shown in FIG. 5B. A wet etch process, may be used to remove the residual mirror portion of the mirror 103. The wet etch process may include a process using tetramehylammonium, potassium iodide, or iodine. The wet etching process may etch all residual portions of the mirror 103, which are not covered by the first resist 501.

At operation 404, the first resist 302 is removed, as shown in FIG. 5C. The resist 302 is removed according to one or more etching processes. The etching process at operation 404 may include a wet etching process using tetramethylammonium or a dry etching process using O₂ plasma, an organic solvent such as propylene glycol methyl ether acetate (PGMEA,) or using a flood exposure procedure followed by tetramethylamoonium hydroxide (TMAH) solvent to etch the residual portion of the encapsulation layer 104. The etching process may remove the first resist 501, such that the mirror 103 remains only where the first resist 501 remained, as shown in FIG. 5C.

At operation 405, an encapsulation layer 104 is deposited over the mirror 103 and the output coupler 105, as shown in FIG. 5D. The encapsulation layer 104 can be deposited by PVD or another vapor deposition process (e.g., CVD or ALD). The encapsulation layer 104 can be deposited or otherwise formed by one or more processes or techniques, such as CVD, plasma-enhanced CVD (PE-CVD), sub-atmospheric CVD (SA-CVD), high density plasma CVD (HDP-CVD), flowable CVD (FCVD® processes), ALD, furnace or thermal ALD, thermal ALD, plasma-enhanced ALD (PE-ALD), PVD, sputtering, evaporation deposition, ion beam deposition, or any combination thereof.

At operation 406, a second resist 502 is formed over the mirror 103, in which a residual encapsulation portion of the encapsulation layer 104 over a non-input coupler area is exposed by the second resist 502, as shown in FIG. 5E. The second resist 502 protects the encapsulation layer 104 from being etched during subsequent processing steps. The second resist 502 is formed such that it is wider than the mirror 103 to produce sidewall protection of the mirror 103 during later processing steps. The resist 502 may, for example, include any resist 302 or resist 501 described herein. The second resist 502 can be formed by block photo lithography procedure, e.g., spin-coating the resist, baking, exposing with patter, and developing the area to remove the resist at an area where the input coupler is not present on the waveguide.

At operation 407, the residual encapsulation portion of the encapsulation layer 104 is removed, in which the output coupler 105 of the waveguide 100 is exposed, as shown in FIG. 5F. For example, the etching process at operation 407 may include etching a chrome layer with a chrome etchant, e.g., ceric ammonium/acetic acid, to etch the residual portion of the encapsulation layer 104. The second resist 502, being wider than the mirror 103 allows the encapsulation layer 104 to remain both on the side of the mirror 103 as well as above the mirror, as shown in FIG. 5F. This allows for mirror 103 protection from oxidants and potential etching complications.

At operation 408, the second resist 502 is removed from waveguide 100, in which the waveguide 100 has the mirror 103 only over the input coupler 102 and the encapsulation layer 104 is only over the mirror 103 or over the mirror 103 and exterior portions of the input coupler 102 surrounding a grating of the input coupler 102, as shown in FIG. 5G. The encapsulation layer 104 may remain over one or more side walls of the mirror 103. The second resist 502 is removed according to one or more etching processes. The etching process at operation 408 may include a wet etching process using tetramethylammonium or a dry etching process using O₂ plasma, an organic solvent such as propylene glycol methyl ether acetate (PGMEA,) or using a flood exposure procedure followed by tetramethylamoonium hydroxide (TMAH) solvent to etch the residual portion of the encapsulation layer 104. The etching process may remove the second resist 502, such that only the input coupler 102 includes an encapsulation layer 104 disposed on the mirror 103, providing protection on the top layer of the mirror 103 and on the sidewalls of the mirror 103.

Overall, the methods described herein provide for a waveguide having mirror only over the input coupler with an encapsulation layer only over the mirror or over the mirror and exterior portions of the input coupler surrounding a grating of the input coupler. The mirror layer only over the input coupler with the encapsulation layer provides a barrier to oxygen, sulfur, and moisture ingress. The encapsulation layer protects the mirror from corroding in ambient atmospheres.

While the foregoing is directed to embodiments of the present disclosure, other and further embodiments of the disclosure may be devised without departing from the basic scope thereof, and the scope thereof is determined by the claims that follow.

1. A device, comprising:
a substrate, the substrate comprising:
an input coupler comprising a first arrangement of waveguide structures, the first arrangement of waveguide structures having a critical dimension defining one or more gaps between each waveguide structure of the first arrangement of waveguide structures;
an output coupler comprising a second arrangement of waveguide structures, the second arrangement of waveguide structures having a critical dimension defining one or more gaps between each waveguide structure of the second arrangement of waveguide structures;
a mirror disposed only on the input coupler, the mirror disposed between the one or more gaps between each waveguide structure of the first arrangement of waveguide structures,
an encapsulation layer disposed on the mirror, the encapsulation layer having a refractive index of about 1.0 to about 1.5; and
a medium, disposed on the output coupler, the medium disposed between the one or more gaps between each waveguide structure of the second arrangement of waveguide structures.

2. The device of claim 1, wherein the encapsulation layer is disposed on a top side of the mirror.

3. The device of claim 2, wherein the encapsulation layer is further disposed on one or more side walls of the mirror.

4. The device of claim 1, wherein the mirror comprises a reflectivity of greater than 90%.

5. A method, comprising:
depositing a mirror on a waveguide, the waveguide having an input coupler and an output coupler;
depositing an encapsulation layer on the mirror;
forming a resist over the input coupler, wherein a residual encapsulation portion of the encapsulation layer on a non-input coupler area is exposed;
removing the residual encapsulation portion of the encapsulation layer, wherein a residual mirror portion of the mirror on the non-input coupler area is exposed;
removing the residual mirror portion of the mirror of the input coupler, wherein the non-input coupler area of the waveguide is exposed; and
removing the resist on the input coupler, the waveguide having the mirror only on the input coupler and the encapsulation layer only on the mirror.

6. The method of claim 5, wherein the forming the resist over the input coupler comprises:
depositing a resist layer over the encapsulation layer; and
patterning the resist layer such that the residual encapsulation portion is exposed.

7. The method of claim 5, wherein depositing the encapsulation layer comprises performing one or more vapor deposition processes.

8. The method of claim 7, wherein performing one or more vapor deposition processes comprises generating an oxygen plasma.

9. The method of claim 5, wherein the encapsulation layer is chromium or silicon nitride.

10. The method of claim 5, wherein the mirror is silver or aluminum.

11. The method of claim 5, wherein removing the residual encapsulation portion of the encapsulation layer comprises using an etching process to etch the residual portion of the encapsulation layer.

12. The method of claim 11, wherein the etching process is a wet etching process or a dry etching process.

13. A method, comprising:
depositing a mirror on a waveguide, the waveguide having an input coupler and an output coupler;
forming a first resist over the input coupler, wherein a residual mirror portion of the mirror on a non-input coupler area is exposed;
removing the residual mirror portion of the mirror on the non-input coupler area;
removing the first resist;
depositing an encapsulation layer on the mirror and the non-input coupler area;
forming a second resist over the mirror, wherein a residual encapsulation portion of the encapsulation layer on the non-input coupler area is exposed by the second resist;
removing the residual encapsulation portion, wherein the non-input coupler area of the waveguide is exposed; and
removing the second resist, the waveguide having the mirror only on the input coupler, and the encapsulation layer:
only on the mirror; or
on the mirror and exterior portions of the input coupler surrounding a grating of the input coupler.

14. The method of claim 13, wherein the forming the resist over the input coupler comprises:
depositing a resist layer over the encapsulation layer; and
patterning the resist layer such that the residual encapsulation portion is exposed.

15. The method of claim 14, wherein depositing the encapsulation layer comprises performing one or more vapor deposition processes.

16. The method of claim 15, wherein performing one or more vapor deposition processes comprises generating an oxygen plasma.

17. The method of claim 13, wherein the encapsulation layer is chromium or silicon nitride.

18. The method of claim 13, wherein the mirror is silver or aluminum.

19. The method of claim 13, wherein removing the residual encapsulation portion of the encapsulation layer comprises using an etching process to etch the encapsulation layer.

20. The method of claim 19, wherein the etching process is a wet etching process or a dry etching process.
